(19) United States
(12) Patent Application Publication
(10) Pub. No.: US 2021/0164376 A1
(43) Pub. Date: Jun. 3, 2021

(54) SYSTEMS AND METHODS FOR MULTIPOINT REDUCTANT INSERTION

(71) Applicant: Cummins Emission Solutions Inc., Columbus, IN (US)

(72) Inventors: Cassio Silva Mangueira de Assis, Guarulhos (BR); Bruno Carlo Mantovanelli, Sao Paulo (BR)

(73) Assignee: Cummins Emission Solutions Inc., Columbus, IN (US)

(21) Appl. No.: 17/268,135

(22) PCT Filed: Aug. 31, 2018
(86) PCT No.: PCT/US2018/049108

§ 371 Date: Feb. 12, 2021

(51) Int. Cl. F01N 3/20; F01N 3/28

(52) U.S. Cl. CPC F01N 3/208; F01N 3/2892; F01N 2900/1404; F01N 2560/026; F01N 2610/146; F01N 2610/02; F01N 2900/1812

(57) ABSTRACT

An aftertreatment system includes a multipoint injector configured to be operatively coupled to an exhaust tube of the aftertreatment system. The multipoint injector comprises an injector body having a circumferential wall. A plurality of orifices extend through the circumferential wall of the injector body. Each of the plurality of orifices is located at a different circumferential position of the circumferential wall and is configured to insert reductant into an exhaust gas flow path defined by the exhaust tube.

### TECHNICAL FIELD

The present disclosure relates generally to aftertreatment systems for use with internal combustion (IC) engines.

### BACKGROUND

Exhaust aftertreatment systems are used to receive and treat exhaust gas generated by IC engines. Generally exhaust gas aftertreatment systems include any of several different components to reduce the levels of harmful exhaust emissions present in the exhaust gas. For example, certain exhaust gas aftertreatment systems for diesel-powered IC engines include a selective catalytic reduction (SCR) system including a catalyst formulated to convert NOx (NO and NO₂ in some fraction) into harmless nitrogen gas (N₂) and water vapor (H₂O) in the presence of ammonia (NH₃). Generally in such aftertreatment systems, an exhaust reductant, (e.g., a diesel exhaust fluid such as urea) is injected into the SCR system to provide a source of ammonia, and mixed with the exhaust gas to partially reduce the NOx gases. The reduction byproducts of the exhaust gas are then fluidically communicated to the catalyst included in the SCR system to decompose substantially all of the NOx gases into relatively harmless byproducts which are expelled out of the aftertreatment system.

A reductant is generally inserted into the SCR system as the source of ammonia to facilitate the decomposition of constituents such as NOx gases of the exhaust gas (e.g., a diesel exhaust gas) by the catalyst included in the SCR system. Inefficient mixing of the reductant with exhaust gas, or impinging of the reductant on sidewalls of an exhaust tube may result in formation of reductant deposits (e.g., due to crystallization of the reductant) in the exhaust tube and components of the aftertreatment system. Reductant deposits reduce the efficiency of the aftertreatment system and may cause clogging of the exhaust tube demanding frequent cleaning of the exhaust tube. The reductant deposits may also accumulate in downstream components, for example, the SCR system and may reduce a catalytic efficiency thereof. Reductant deposits therefore cause frequent maintenance to be performed on the aftertreatment system increasing maintenance costs.

### SUMMARY

Embodiments described herein relate generally to systems and methods for inserting a reductant into an aftertreatment system, and in particular to reductant insertion systems that include a multipoint injector having a plurality of circumferentially located orifices and a reductant distributor coupled to the multipoint injector and configured to selectively provide reductant to one or more orifices of the multipoint injector.

In some embodiments, a multipoint injector configured to be operatively coupled to an exhaust tube of an aftertreatment system comprises an injector body having a circumferential wall. A plurality of orifices extend through the circumferential wall of the injector body, each being located at a different circumferential position of the circumferential wall and being configured to insert reductant into an exhaust gas flow path defined by the exhaust tube.

In some embodiments, a method for inserting a reductant into an exhaust tube of an aftertreatment system via a multipoint injector fluidly coupled to the exhaust tube comprises determining an operating parameter of the exhaust gas. The multipoint injector comprises an injector body having a circumferential wall and a plurality of orifices extending through the circumferential wall, each being located at a different circumferential position of the circumferential wall. The reductant is inserted through at least a portion of the plurality of orifices into a flow path of an exhaust gas flowing through the exhaust tube based on the operating parameter.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a schematic block diagram of an aftertreatment system, according to an embodiment.

FIG. 2 is schematic block diagram of a control circuitry that can include a controller of the aftertreatment system of FIG. 1, according to an embodiment.

FIG. 3A is a front perspective view and FIG. 3B is a rear perspective view of a reductant distributor, according to another embodiment.

FIG. 4 is a perspective view of an exhaust tube showing a multipoint injector coupled thereto, according to an embodiment.

FIG. 5 is a side perspective view of the multipoint injector of FIG. 4.

FIG. 6A is a side cross-section view of the multipoint injector of FIG. 5; FIG. 6B is an enlarged view of a portion of the multipoint injector indicated by the arrow A in FIG. 6A;

FIG. 6C is a schematic illustration showing a side cross-section of the multipoint injector of FIG. 6A to show an orifice defined through a circumferential sidewall of the multipoint injector.

FIG. 7A is a front view and FIG. 7B is a side cross-section view of a portion of the exhaust tube of FIG. 4 showing a reductant being inserted through each of a plurality of orifices of the multipoint injector into an exhaust gas flow path defined through the multipoint injector.

FIGS. 8A, 9A and 10A show reductant being inserted through a first set, a second set and a third set of the plurality of orifices of the multipoint injector, respectively, and FIGS. 8B, 9B and 10B show the corresponding outlets of a reductant distributor through which reductant is supplied to the orifices of the multipoint injector.

FIGS. 11A-11D show various patterns of reductant insertion by the multipoint injector by activating various combinations of the plurality of orifices of the multipoint injector.

FIG. 12 is a schematic flow diagram of a method for inserting a reductant into an exhaust tube of an aftertreatment system via a multipoint injector, according to an embodiment.

FIG. 13 is a schematic block diagram of an embodiment of a computing device which can be used as the controller of FIG. 1 or FIG. 2.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Embodiments described herein relate generally to systems and methods for delivering a reductant to an aftertreatment system, and in particular to reductant insertion systems that include a multipoint injector having a plurality of circumferentially located orifices and a reductant distributor coupled to the multipoint injector and configured to selectively provide reductant to one or more orifices of the multipoint injector.

Reductant injectors are used to insert reductant into a flow path of an exhaust gas flowing through an aftertreatment system. The reductant may form reductant deposits (e.g., due to crystallization or incomplete decomposition of the reductant) in an exhaust tube and/or components of the aftertreatment system. Conventional reductant injectors generally insert reductant into the same location of an exhaust tube to which the injector is coupled. This causes reductant to repeatedly impinge on the same location of a wall of the exhaust tube which increases deposition of reductant deposits in the exhaust tube. Reductant deposits reduce the efficiency of the aftertreatment system and may cause clogging of the exhaust tube demanding frequent cleaning of the exhaust tube. The reductant deposits may also accumulate in downstream components, for example, the SCR system and may reduce a catalytic efficiency thereof. Reductant deposits therefore cause frequent maintenance to be performed on the aftertreatment system increasing maintenance costs.

Various embodiments of the multipoint injector described herein may provide benefits including, for example: (1) providing insertion of reductant at a plurality of circumferential locations causing better mixing of the reductant with the exhaust gas so to reduce crystallization and formation of reductant deposits; (2) allowing selective insertion of reductant at various spray angles and droplet size to provide different reductant droplet size and spray angles; (3) reducing a rate of impingement of the reductant at the same location of the exhaust tube by allowing cycling of insertion of the reductant through the orifices, thereby reducing reductant deposits and accumulation on any one location of the aftertreatment system; (4) inserting reductant through smaller orifices provided in the multipoint injector which provides smaller reductant droplets facilitating reductant evaporation and reducing reductant deposits; (5) allowing control of droplet size and pattern based on reductant demand; (6) reducing maintenance intervals therefore, reducing maintenance costs; and (7) removable coupling of the multipoint injector allowing easy replacement and further reducing maintenance costs.

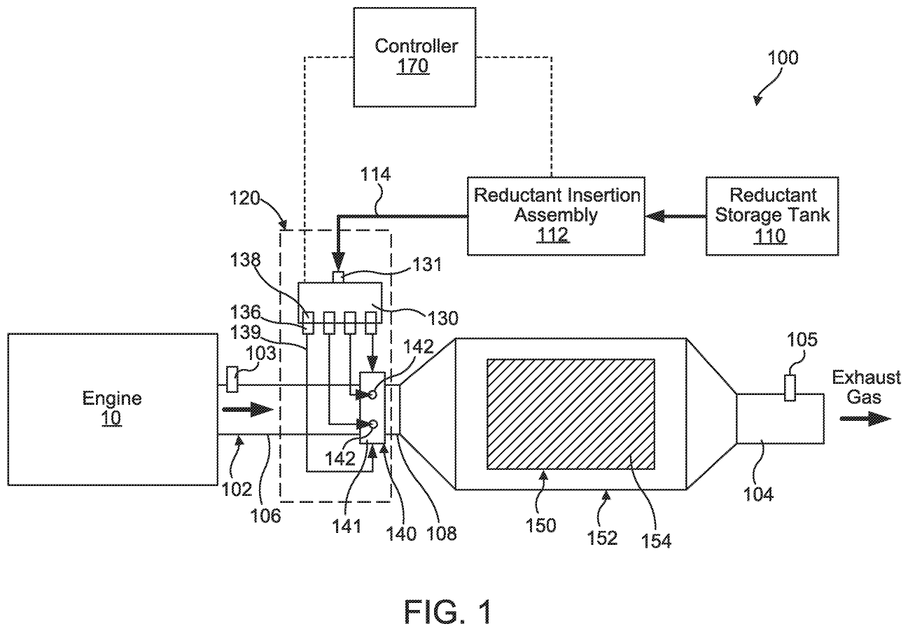

FIG. 1 is a schematic illustration of an aftertreatment system 100, according to an embodiment. The aftertreatment system 100 is configured to receive an exhaust gas (e.g., a diesel exhaust gas) from an engine 10 and the reduce constituents of the exhaust gas such as, for example, NOx gases, CO, etc. The aftertreatment system 100 includes a reductant storage tank 110, a reductant insertion assembly 112, a reductant insertion system 120 comprising a multipoint injector 140 and a reductant distributor 130, a SCR system 150 and a controller 170.

The engine 10 may be an IC engine, for example a diesel engine, a gasoline engine, a natural gas engine, a biodiesel engine, a dual fuel engine, an alcohol engine, an E85 or any other suitable internal combustion engine.

The reductant storage tank 110 contains an exhaust reductant formulated to facilitate decomposition (e.g., reduction) of the constituents of the exhaust gas (e.g., NOx gases) by a catalyst 154 included in the SCR system 150. In embodiments in which the exhaust gas is a diesel exhaust gas, the exhaust reductant can include a diesel exhaust fluid (DEF) which provides a source of ammonia. Suitable DEFs can include urea, aqueous solution of urea or any other DEF (e.g., the DEF available under the tradename ADBLUE®). In particular embodiments, the reductant includes an aqueous urea solution containing 32.5% urea and 67.5% de-ionized water. In other embodiments, the reductant includes aqueous urea solution containing 40% urea and 60% de-ionized water.

The SCR system 150 is configured to receive and treat the exhaust gas (e.g., a diesel exhaust gas) flowing through the SCR system 150 via an exhaust tube 102 defining an exhaust flow path for communicating the exhaust gas from the engine 10 to the SCR system 150 and/or any other components positioned therewithin or downstream thereof. The SCR system 150 is fluidly coupled to the reductant storage tank 110 so as to receive the reductant therefrom via the reductant insertion assembly 112, as described herein. The aftertreatment system 100 may also include an outlet tube 104 positioned downstream of the SCR system 150 and structured to expel treated exhaust gas into the environment.

A first sensor 103 may be positioned in the exhaust tube 102. The first sensor 103 may include, for example, a NOx sensor (e.g., a physical or virtual NOx sensor), an oxygen sensor, a particulate matter sensor, a carbon monoxide sensor, a temperature sensor, a pressure sensor, any other sensor or a combination thereof configured to measure one or more operational parameters of the exhaust gas. Such operating parameters may include, for example, an amount of NOx gases in the exhaust gas, a temperature of the exhaust gas, a flow rate and/or pressure of the exhaust gas.

A second sensor 105 may be positioned in the outlet tube 104. The second sensor 105 may comprise a second NOx sensor configured to determine an amount of NOx gases expelled into the environment after passing through the SCR system 150. In other embodiments, the second sensor 105 may comprise a PM sensor configured to determine an amount of PM (e.g., soot or ash included in the exhaust gas). In still other embodiments, the second sensor 105 may comprise an ammonia sensor configured to measure an amount of ammonia in the exhaust gas flowing out of the SCR system 150, i.e., determine the ammonia slip. The ammonia slip may be used as a measure of catalytic efficiency of the SCR system 150, for adjusting an amount of reductant to be inserted into the SCR system 150, and/or for adjusting a temperature of the SCR system 150 so as to allow the SCR system 150 to effectively use the ammonia for catalytic decomposition of the NOx gases included in the exhaust gas flowing therethrough. In some embodiments, an ammonia oxide (AMOx) catalyst may be positioned downstream of the SCR system 150, for example, in the outlet tube 104 so as to decompose any unreacted ammonia in the exhaust gas downstream of the SCR system 150.

The SCR system 150 comprises a housing 152 containing at least one catalyst 154. In some embodiments, the SCR system 150 may comprise a selective catalytic reduction filter (SCRF), or any other aftertreatment component configured to decompose constituents of the exhaust gas (e.g., NOx gases such as such nitrous oxide, nitric oxide, nitrogen dioxide, etc.), flowing therethrough in the presence of a reductant, as described herein. Any suitable catalyst 154 can be used such as, for example, platinum, palladium, rhodium, cerium, iron, manganese, copper, and/or vanadium based catalysts (including combinations thereof).

The catalyst 154 can be disposed on a suitable substrate such as, for example, a ceramic (e.g., cordierite) or metallic (e.g., kanthal) monolith core which can, for example, define a honeycomb structure. A washcoat can also be used as a carrier material for the catalyst 154. Such washcoat materials can include, for example, aluminum oxide, titanium dioxide, silicon dioxide, any other suitable washcoat material, or a combination thereof. The exhaust gas can flow over and about the catalyst 154 such that NOx gases included in the exhaust gas are further reduced to yield an exhaust gas which is substantially free of carbon monoxide and NOx gases.

In various embodiments, the aftertreatment system 100 may also include other aftertreatment components such as, for example, an oxidation catalyst (e.g., a diesel oxidation catalyst), one or more particulate matter filters, ammonia oxidation catalysts, mixers, baffle plates, or any other suitable aftertreatment component. Such aftertreatment components may be positioned upstream (e.g., positioned within the exhaust tube 102) or downstream of the SCR system 150.

The reductant insertion assembly 112 is fluidly coupled to the reductant storage tank 110. The reductant insertion assembly 112 is configured to provide the reductant to the reductant insertion system 120 positioned upstream of the SCR system 150. The reductant insertion assembly 112 may comprise various structures to facilitate receipt of the reductant from the reductant storage tank 110 and delivery to the SCR system 150.

In various embodiments, the reductant insertion assembly 112 may also include one or more pumps (e.g., a diaphragm pump, a positive displacement pump, a centrifugal pump, a vacuum pump, etc.) for delivering the reductant to SCR system 150 at an operating pressure and/or flow rate. The reductant insertion assembly 112 may also include filters and/or screens (e.g., to prevent solid particles of the reductant or contaminants from flowing into the one or pumps) and/or valves (e.g., check valves) to receive reductant from the reductant storage tank 110. Screens, check valves, pulsation dampers, or other structures may also be positioned downstream of the one or more pumps of the reductant insertion assembly 112 and configured to remove contaminants and/or facilitate delivery of the reductant to the SCR system 150.

In various embodiments, the reductant insertion assembly 112 may also comprise a bypass line structured to provide a return path of the reductant from the one or more pumps to the reductant storage tank 110. A valve (e.g., an orifice valve) may be provided in the bypass line. In various embodiments, the reductant insertion assembly 112 may also comprise a blending chamber structured to receive pressurized reductant from a metering valve at a controllable rate. The blending chamber may also be structured to receive air (e.g., compressed air or portion of the exhaust gas), or any other inert gas (e.g., nitrogen), for example, from an air supply unit so as to deliver a combined flow of the air and the reductant to the SCR system 150 through the reductant port.

The multipoint injector 140 is operatively coupled to the exhaust tube 102 and configured to provide multipoint insertion of the reductant into the exhaust gas flow path. The multipoint injector 140 comprises an injector body 141 having a circumferential wall. For example, the injector body 141 may comprise a ring shaped member positioned within the exhaust tube 102 or coupled thereto. In some embodiments, the exhaust tube 102 may comprise an exhaust tube first portion 106 positioned upstream of the injector body 141 and an exhaust tube second portion 108 positioned downstream of the injector body 141 such that the injector body 141 defines a channel therethrough, the channel forming a portion of the exhaust gas flow path.

In some embodiments, the multipoint injector 140 may also include a plurality of flanges positioned at axial ends of the injector body 141 and extending radially outwards from the injector body 141. The flanges abut corresponding axial ends of the exhaust tube first portion 106 and the exhaust tube second portion 108 and are coupled thereto. In some embodiments, the injector body 141 may be removably coupled to the exhaust tube first and second portions 106 and 108, for example, via screws, nuts, bolts, coupling bands or any other suitable coupling mechanism. In other embodiments, the injector body 141 may be fixedly coupled to the exhaust tube first and second portions 106 and 108, for example, welded thereto.

As shown in FIG. 1, a plurality of orifices 142 extend through a circumferential wall of the injector body 141. Each of the plurality of orifices 142 is configured to receive reductant through a corresponding reductant delivery line 139 for independently inserting reductant into the exhaust gas flow path. Each of the plurality of orifices 142 is located at a different circumferential position of the circumferential wall of the injector body 141 and is configured to radially insert reductant into the exhaust gas flow path defined by the exhaust tube 102, i.e., the channel defined by the injector body 141. Any number of orifices 142 may be defined through the circumferential wall, for example 3, 4, 5, 6, 7, 8, 9, 10, 11, 12 or even more.

The plurality of orifices may have a small diameter, for example, in a range of 0.40 mm to 0.55 mm. The small diameter of the orifices 142 produce a small droplet size of the reductant which rapidly evaporates in the exhaust gas, therefore enhancing mixing and reducing reductant deposits. At least a portion of the plurality of orifices 142 are inclined with respect to a flow axis of the exhaust gas flow path. In some embodiments, each of the plurality of orifices are inclined at the same angle with respect to a flow axis of the exhaust gas flow path. In some embodiments, each of the plurality of orifices 142 may have the same size (e.g., the same length or diameter). In other embodiments, at least some of the plurality of orifices 142 may have a different size from other orifices 142. The different sized orifices 142 may be selectively activated to vary the droplet size, volume and/or flow rate of the reductant inserted into the exhaust gas flow path (e.g., based on one or more operating parameters of the aftertreatment system 100 such as exhaust gas temperature, flow rate, pressure, amount of NOx gases in exhaust gas, etc.).

In some embodiments, a plurality of reductant delivery lines 139 may be used to deliver the reductant from the reductant insertion assembly 112 to a corresponding orifice 142. A reductant distributor 130 may be used to provide reductant to each of the plurality of orifices 142. For example, as shown in FIG. 1, the reductant insertion system 120 also comprises the reductant distributor 130 configured to selectively provide reductant to the plurality of orifices 142. The reductant distributor 130 comprises an inlet 131 fluidly coupled to the reductant insertion assembly 112 via a reductant receiving line 114 and configured to receive the reductant from the reductant insertion assembly 112. The reductant distributor 130 also comprises a plurality of outlets 136 coupled via a corresponding reductant delivery line 139 to a corresponding orifice 142 of the plurality of orifices 142.

The reductant distributor 130 also comprises a plurality of valves 138. Each of the plurality of valves 138 is operatively coupled to a corresponding outlet 136 and configured to be selectively activated to communicate reductant to a set of orifices 142 of the plurality of orifices 142. For example, one or more of the valves 138 may be opened at any given time to cause the reductant to be delivered through the corresponding orifice 142 of the multipoint injector 140 via the corresponding reductant delivery line 139.

In some embodiments, the reductant distributor 130 may be located remotely from the multipoint injector 140 and, therefore the exhaust tube 102. This may prevent exposure of the reductant distributor 130 to high temperature in the vicinity of the exhaust tube 102 which may cause decomposition of the reductant contained within the reductant distributor 130. This prevents crystallization and/or formation of reductant deposits within the reductant distributor 130 which can clog the valves 138. While not shown, in some embodiments, a bypass line or a reductant return line may be provided in the reductant distributor to allow flushing of the reductant from the reductant distributor 130 and return of the reductant to the reductant storage tank 110, for example, when the aftertreatment system 100 is turned OFF (e.g., due to engine 10 turning OFF). This may prevent solidification of the reductant within the reductant distributor, for example, when an ambient temperature is below −10 degrees Celsius.

The controller 170 may be operatively coupled to the reductant insertion assembly 112 and the reductant distributor 130. The controller 170 may be configured to determine an operating parameter of the exhaust gas and activate the reductant insertion assembly 112 based on the operating parameter of the exhaust gas, for example, exhaust gas starting to flow through the aftertreatment system 100 (e.g., due to engine 10 turning ON), a temperature, flow rate and/or pressure of the exhaust gas, and/or amount of NOx gases included in the exhaust gas. In some embodiments, the controller 170 may be configured to determine the operating parameter via a signal received from engine 10 (e.g., an engine ON or OFF signal), from the first sensor 103, the second sensor 105 and/or any other sensor included in the aftertreatment system 100 (e.g., an exhaust gas temperature, pressure, flow rate, or NOx sensor).

The controller 170 may be configured to selectively activate (i.e., open) a set of the plurality of valves 138 so as to allow the reductant to be communicated to a corresponding set of orifices 142 of the plurality of orifices 142. For example, the controller 170 may be configured to determine an operating parameter of the exhaust gas, and selectively activate the set of the plurality of valves 138 based on the operating parameter of the exhaust gas.

In some embodiments, the controller 170 is configured to activate each of the plurality of valves 138 simultaneously. In other embodiments, the controller 170 may be configured to activate a first set of the plurality of valves 138 at a first time point causing the reductant to be inserted through a corresponding first set of orifices 142 into a first location of the exhaust gas flow path. In other embodiments, the controller 170 may be configured to activate a second set of the plurality of valves 138 different than the first set of the plurality of valves 138 at a second time point causing the reductant to be inserted through a corresponding second set of orifices 142 into a second location of the exhaust gas flow path different from the first location. The first set of the plurality of valves 138 are closed at the second time point.

The controller 170 may be operatively coupled to the components of the aftertreatment system 100 using any type and any number of wired or wireless connections. For example, a wired connection may include a serial cable, a fiber optic cable, a CAT5 cable, or any other form of wired connection. Wireless connections may include the Internet, Wi-Fi, cellular, radio, Bluetooth, ZigBee, etc. In one embodiment, a controller area network (CAN) bus provides the exchange of signals, information, and/or data. The CAN bus includes any number of wired and wireless connections.

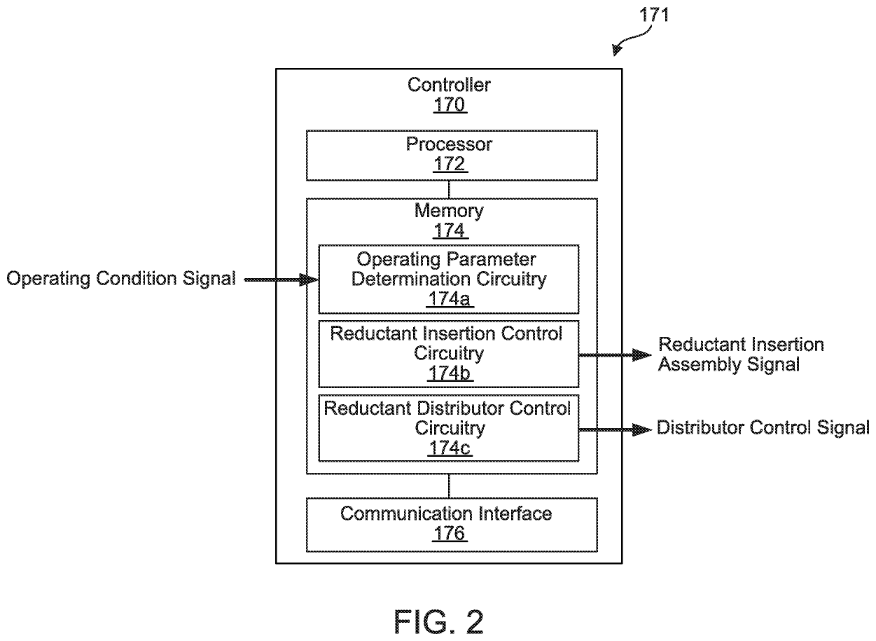

In particular embodiments, the controller 170 may be included in a control circuitry. For example, FIG. 2 is a schematic block diagram of a control circuitry 171 that comprises the controller 170, according to an embodiment. The controller 170 comprises a processor 172, a memory 174, or any other computer readable medium, and a communication interface 176. Furthermore, the controller 170 includes an operating parameter determination circuitry 174a, a reductant insertion control circuitry 174b and a reductant distributor control circuitry 174c. It should be understood that the controller 170 shows only one embodiment of the controller 170 and any other controller capable of performing the operations described herein can be used (e.g., the computing device 430).

The processor 172 can comprise a microprocessor, programmable logic controller (PLC) chip, an ASIC chip, or any other suitable processor. The processor 172 is in communication with the memory 174 and configured to execute instructions, algorithms, commands, or otherwise programs stored in the memory 174.

The memory 174 comprises any of the memory and/or storage components discussed herein. For example, memory 174 may comprise a RAM and/or cache of processor 172. The memory 174 may also comprise one or more storage devices (e.g., hard drives, flash drives, computer readable media, etc.) either local or remote to controller 170. The memory 174 is configured to store look up tables, algorithms, or instructions.

In one configuration, the operating parameter determination circuitry 174a, the reductant insertion control circuitry 174b and the reductant distributor control circuitry 174c are embodied as machine or computer-readable media (e.g., stored in the memory 174) that is executable by a processor, such as the processor 172. As described herein and amongst other uses, the machine-readable media (e.g., the memory 174) facilitates performance of certain operations to enable reception and transmission of data. For example, the machine-readable media may provide an instruction (e.g., command, etc.) to, e.g., acquire data. In this regard, the machine-readable media may include programmable logic that defines the frequency of acquisition of the data (or, transmission of the data). Thus, the computer readable media may include code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, etc.).

In another configuration, the operating parameter determination circuitry 174a, the reductant insertion control circuitry 174b and the reductant distributor control circuitry 174c are embodied as hardware units, such as electronic control units. As such, the operating parameter determination circuitry 174a, the reductant insertion control circuitry 174b and the reductant distributor control circuitry 174c may be embodied as one or more circuitry components including, but not limited to, processing circuitry, network interfaces, peripheral devices, input devices, output devices, sensors, etc.

In some embodiments, the operating parameter determination circuitry 174a, the reductant insertion control circuitry 174b and the reductant distributor control circuitry 174c may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the operating parameter determination circuitry 174a, the reductant insertion control circuitry 174b and the reductant distributor control circuitry 174c may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on.

Thus, the operating parameter determination circuitry 174a, the reductant insertion control circuitry 174b and the reductant distributor control circuitry 174c may also include programmable hardware devices such as field programmable gate arrays, programmable array logic, programmable logic devices or the like. In this regard, the operating parameter determination circuitry 174a, the reductant insertion control circuitry 174b and the reductant distributor control circuitry 174c may include one or more memory devices for storing instructions that are executable by the processor(s) of the operating parameter determination circuitry 174a, the reductant insertion control circuitry 174b and the reductant distributor control circuitry 174c. The one or more memory devices and processor(s) may have the same definition as provided below with respect to the memory 174 and the processor 172.

In the example shown, the controller 170 includes the processor 172 and the memory 174. The processor 172 and the memory 174 may be structured or configured to execute or implement the instructions, commands, and/or control processes described herein with respect the operating parameter determination circuitry 174a, the reductant insertion control circuitry 174b and the reductant distributor control circuitry 174c. Thus, the depicted configuration represents the aforementioned arrangement where the operating parameter determination circuitry 174a, the reductant insertion control circuitry 174b and the reductant distributor control circuitry 174c are embodied as machine or computer-readable media. However, as mentioned above, this illustration is not meant to be limiting as the present disclosure contemplates other embodiments such as the aforementioned embodiment where the operating parameter determination circuitry 174a, the reductant insertion control circuitry 174b and the reductant distributor control circuitry 174c, or at least one circuit of the operating parameter determination circuitry 174a, the reductant insertion control circuitry 174b and the reductant distributor control circuitry 174c are configured as a hardware unit. All such combinations and variations are intended to fall within the scope of the present disclosure.

The processor 172 may be implemented as one or more general-purpose processors, an application specific integrated circuit (ASIC), one or more field programmable gate arrays (FPGAs), a digital signal processor (DSP), a group of processing components, or other suitable electronic processing components. In some embodiments, the one or more processors may be shared by multiple circuits (e.g., the operating parameter determination circuitry 174a, the reductant insertion control circuitry 174b and the reductant distributor control circuitry 174c) may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure. The memory 174 (e.g., RAM, ROM, Flash Memory, hard disk storage, etc.) may store data and/or computer code for facilitating the various processes described herein. The memory 174 may be communicatively connected to the processor 172 to provide computer code or instructions to the processor 172 for executing at least some of the processes described herein. Moreover, the memory 174 may be or include tangible, non-transient volatile memory or non-volatile memory. Accordingly, the memory 174 may include database components, object code components, script components, or any other type of information structure for supporting the various activities and information structures described herein.

The communication interface 176 may include wireless interfaces (e.g., jacks, antennas, transmitters, receivers, communication interfaces, wire terminals, etc.) for conducting data communications with various systems, devices, or networks. For example, the communication interface 176 may include an Ethernet card and port for sending and receiving data via an Ethernet-based communications network and/or a Wi-Fi communication interface for communicating with, for example, the first sensor 103, the second sensor 105, the engine 10, the reductant insertion assembly 112, the reductant distributor 130 and/or any other component of the aftertreatment system 100. The communication interface 176 may be structured to communicate via local area networks or wide area networks (e.g., the Internet, etc.) and may use a variety of communications protocols (e.g., IP, LON, Bluetooth, ZigBee, radio, cellular, near field communication, etc.).

The operating parameter determination circuitry 174a may be configured to receive an operating condition signal (e.g., from the engine 10, the first sensor 103, the second sensor 105 or any other sensors included in the aftertreatment system 100) and determine an operating condition of the exhaust gas therefrom (e.g., an exhaust gas temperature, pressure, flow rate and/or amount of NOx gases included in the exhaust gas).

The reductant insertion control circuitry 174b is configured to use the operating condition of the exhaust gas to generate a reductant insertion assembly signal configured to activate the reductant insertion assembly 112 (e.g., turn ON a pump of the reductant insertion assembly 112) and/or open a dosing valve of the reductant insertion assembly 112, for example, to cause a reductant to flow from the reductant insertion assembly 112 to the reductant distributor 130. For example, the reductant insertion control circuitry 174b may be configured to activate the reductant insertion assembly 112 in response to the engine 10 turning ON, which corresponds to commencement of flow of the exhaust gas through the aftertreatment system 100, and/or the exhaust gas temperature, pressure, flow rate, and/o amount of NOx gases included in the exhaust gas being equal to or greater than a predetermined threshold. In other embodiments, the reductant insertion control circuitry 174b may be configured to activate the reductant insertion assembly 112 in response to a volume of ammonia stored in the catalyst 152 of the SCR system 150 being less than a predetermined threshold. Similarly, the reductant insertion control circuitry 174b may be configured to deactivate the reductant insertion assembly 112 (e.g., turn OFF a pump or close the dosing valve of the reductant insertion assembly 112) in response to a different operating condition signal (e.g., corresponding to the engine 10 turning OFF, temperature, pressure, flow rate and/or amount of NOx gases included in the exhaust gas being less than the predetermined threshold, and/or the amount of ammonia stored in the SCR system 150 being equal to or greater than the predetermined threshold).

The reductant distributor control circuitry 174c is configured activate one or more of the plurality of valves 138 included in the reductant distributor 130 for inserting the reductant into the exhaust gas flow path via the corresponding orifices 142 fluidly coupled to the activated valves 138. The reductant distributor control circuitry 174c may be configured to selectively activate any suitable combination of the plurality of valves 138 to provide a desired flow pattern, volume and/or insertion rate of the reductant through the corresponding orifices 142. In some embodiments, the reductant distributor control circuitry 174c may be configured to activate each of the plurality of valves 138 simultaneously. In other embodiments, the reductant distributor control circuitry 174c may be configured to activate a first set of the plurality of valves 138 at first time point causing the reductant to be inserted through a corresponding first set of orifices 142 into a first location of the exhaust gas flow path. Furthermore, the reductant distributor control circuitry 174c may be further configured to activate a second set of the plurality of valves 138 different than the first set of valves 138 at a second time point causing the reductant to be inserted through a corresponding second set of orifices 142 into a second location of the exhaust gas flow path different than the first location.

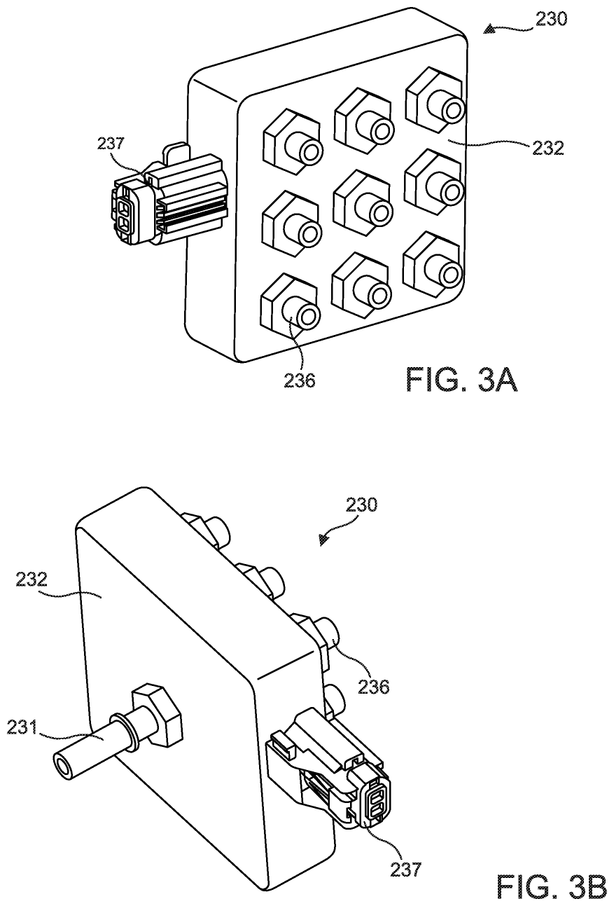

FIGS. 3A-3B is a perspective view of a reductant distributor 230, according to an embodiment. The reductant distributor 230 comprises a reductant distributor housing 232 defining a plurality of outlets 236 on a first side wall thereof. While shown as including 9 outlets 236, in various embodiments, the reductant distributor 230 may include any number of outlets 236 (e.g., 3, 4, 5, 6, 7, 8, 9, 10, 11, 12 or even more). The number of outlets 236 correspond to a number of orifices provided in an associated multipoint injector (e.g., the multipoint injector 140, 240). Furthermore, the plurality of outlets 236 may all be defined on a single sidewall (e.g., the first side wall), or distributed among various sidewall of the reductant distributor housing 232. A plurality of valves (not shown) may be disposed within the internal volume of the reductant distributor housing 232, each of the plurality of valves associated with a respective outlet 236 of the reductant distributor 230.

An inlet 231 is provided on a second sidewall of the reductant distributor housing 232 opposite the first sidewall, but may be provided on any other sidewall of the reductant distributor housing 232. The inlet 231 is configured to be coupled to a reductant insertion assembly (e.g., the reductant insertion assembly 112) via a reductant receiving line (e.g., the reductant receiving line 114). The reductant distributor 230 also includes an electrical connector 237 configured to communicatively couple the reductant distributor 230 to a controller (e.g., the controller 170) which may be configured to selectively activate one or more of the plurality of valves 238, as previously described herein.

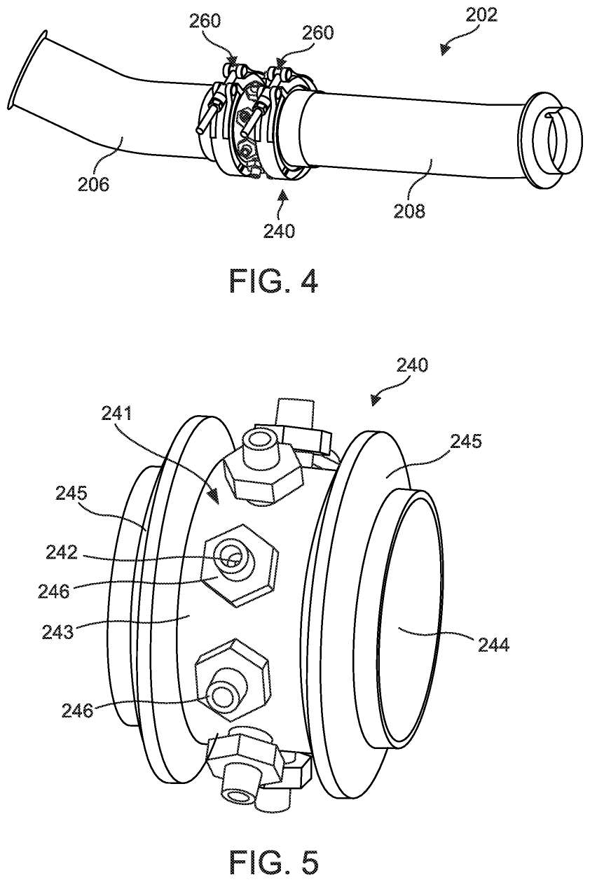

FIG. 4 is a side perspective view of an exhaust tube 202 with a multipoint injector 240 coupled thereto. FIG. 5 is a side perspective view of the multipoint injector 240 uncoupled from the exhaust tube 202. The exhaust tube 202 comprises an exhaust tube first portion 206 positioned upstream of the multipoint injector 240 and an exhaust tube second portion 208 positioned downstream of the multipoint injector 240. The multipoint injector 240 is coupled to the exhaust tube first and second portions 206 and 208 such that the multipoint injector 240 defines a portion of the exhaust gas flow path.

The multipoint injector 240 comprises an injector body 241 having a circumferential wall 243. The injector body 241 may be formed from any suitable heat resistant material, for example, metals or ceramics. While FIGS. 4-5 show the injector body 241 having a circular cross-section, in other embodiments, the injector body 241 may have a non-circular cross-section, for example, square, rectangular, oval, elliptical, or asymmetric corresponding to a cross-section of the exhaust tube 202 or otherwise an exhaust tube (e.g., the exhaust tube 102).

The multipoint injector 240 defines a channel 244 therethrough which forms the portion of the exhaust gas flow path, such that the exhaust gas flows through the channel 244 as it flows through the exhaust tube 202 towards downstream aftertreatment components, for example, an SCR system (e.g., the SCR system 150). A plurality of flanges 245 are formed at axial ends of the injector body 241 and extend radially outwards from the injector body 241. The flanges 245 are coupled to corresponding portions 206 and 208 of the exhaust tube 202 via coupling bands 260. For example, ends of the exhaust tube first and second portions 206 and 208 may be positioned around a portion of the corresponding flanges 245 and clamped thereon via the coupling bands 260. The coupling band 260 includes a winching mechanism (e.g., a lead screw and nut) for clamping the coupling bands 260 around the flanges 245. In this manner, the multipoint injector 240 may be removably coupled to the exhaust tube 202, for example, to facilitate replacement of the multipoint injector 240. This facilitates replacement of the multipoint injector 240 (e.g., due to malfunction) without having to replace the exhaust tube 202. While not shown, a sealing member may positioned between the ends of the exhaust tube first and second portions 206 and 208, and the flanges 245 so as prevent leakage of exhaust gas at the interface.

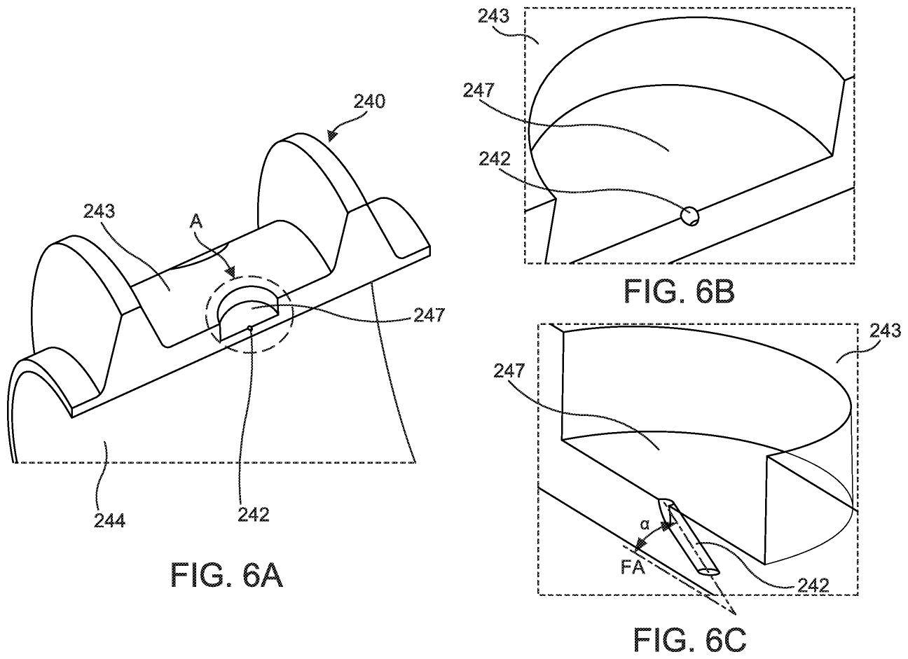

Referring also now to FIGS. 6A-6C, a plurality of orifices 242 extend through the circumferential wall 243 to the channel 244. The orifices 242 may have a diameter in a range of 0.40 mm to 0.55 mm. In some embodiments, each of the plurality of orifices 242 may have the same diameter. In other embodiments, at least some of the orifices 242 may have a different diameter from the other orifices 242. A cavity 247 is defined around each orifice 242 and is configured to receive a fluid connector 246. In some embodiments, threads may be defined on the sidewall of the cavity 247 and structured to engage mating threads defined on the fluid connector 246 to allow coupling of the fluid connector 246 thereto. Reductant delivery lines (e.g., fluidic tubes or hoses) may fluidly couple outlets of a reductant distributor (e.g., the reductant distributor 230) to a corresponding fluid connector 246 for delivering reductant to the corresponding orifice 242 of the plurality of orifices 242.

As shown in FIG. 6C, at least some of the orifices 242 are oriented at an angle α with respect to a flow axis FA of the exhaust gas. In some embodiments, each of the orifices 242 may be oriented at the same angle with respect to the flow axis FA. In other embodiments, one or more of the orifices 242 may be oriented at different angles with respect to the flow axis FA relative to the other orifices 242.

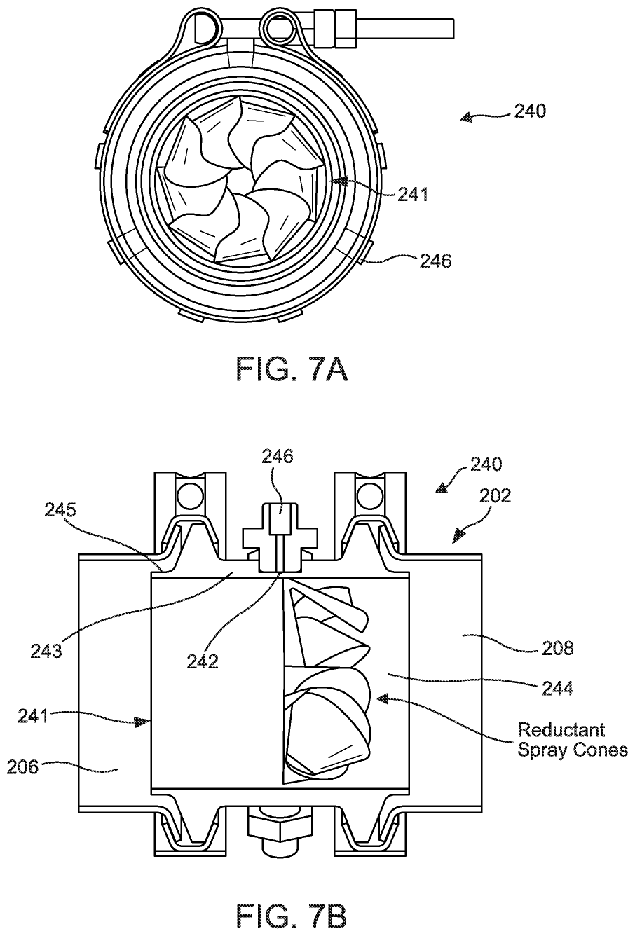

FIG. 7A is a front view and FIG. 7B is a side cross-section view of a portion of the exhaust tube 202 of FIG. 4 that includes the multipoint injector 240 showing the reductant being inserted simultaneously through each of the plurality of orifices 242 of the multipoint injector 240 into the channel 244 defining a portion of the exhaust gas flow path. The reductant spray cones inserted from corresponding orifices 242 overlap with at least one of the other reductant spray cones. This causes the reductant droplets to randomly collide with each other increasing turbulence, which enhances mixing with exhaust gas and reduces reductant deposits.

Since the reductant is inserted in to the channel 244, any impingement of the reductant streams is on an inner surface of the circumferential wall 243 that forms the channel 244 instead of on the inner surface of the exhaust tube 202. Thus any reductant deposit formation is substantially limited to the circumferential wall 243. Therefore, any maintenance performed to remove reductant deposits may be limited to multipoint injector 240 which can easily be removed and reinstalled on the exhaust tube 202. This reduces maintenance costs.

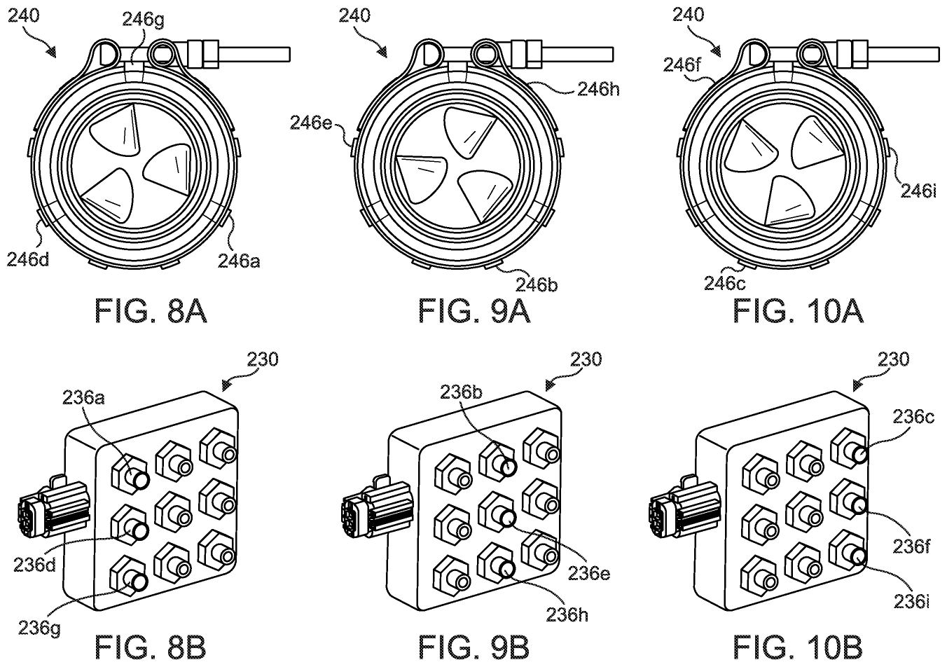

In some embodiments, the reductant distributor 230 or any other reductant distributor may be used to selectively provide reductant to a set of orifices 242 of the plurality of orifices 242. For example, in a first configuration shown in FIGS. 8A-8B, reductant is provided through a first set of outlets 236a/d/g of the reductant distributor 230 to a corresponding first set of fluid connectors 246a/d/g for inserting reductant through the respective orifices 242. In a second configuration shown in FIGS. 9A-9B, the reductant is provided through a second set of outlets 236b/e/h to a corresponding second set of fluid connectors 246b/e/h for inserting reductant through the respective orifices 242, thereby reorienting the reductant spray pattern clockwise. Similarly, in a third configuration shown in FIGS. 10A-10B, the reductant is provided through a third set of outlets 236c/f/i to a corresponding third set of fluid connectors 246c/f/i for inserting reductant through the respective orifices 242, thereby further reorienting the reductant spray pattern clockwise, and so on.

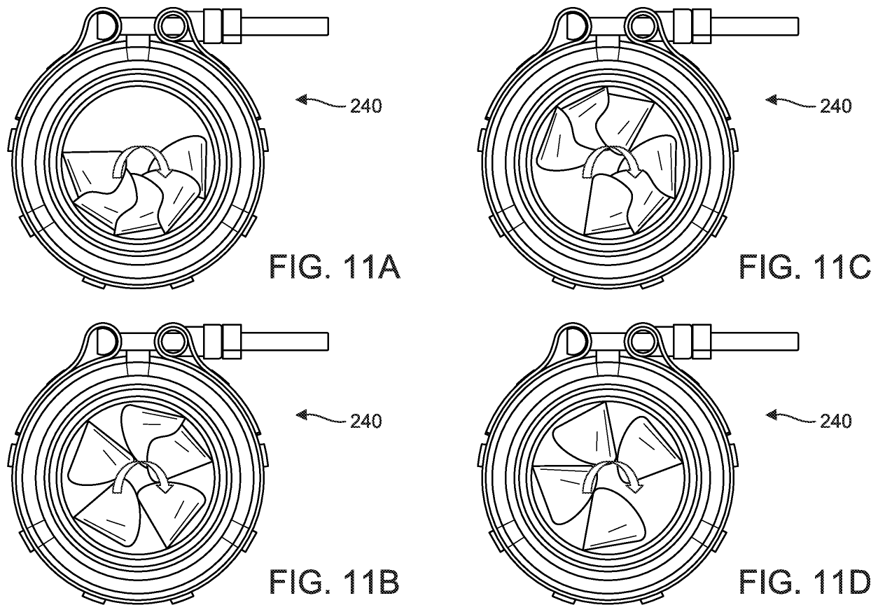

FIGS. 11A-11D show various other operational configurations of inserting the reductant through the multipoint injector 240. FIG. 11A shows an operational configuration in which reductant is inserted through five adjacent orifices 242 and sequentially cycled clockwise. FIG. 11B shows another configuration in which reductant is inserted through a different set of five orifices 242 and cycled clockwise. FIG. 11C shows yet another configuration in which reductant is inserted through six orifices 242 and cycled clockwise. Three of the orifices 242 are located on one side of the circumferential wall 243 and the remaining three orifices 242 are located on opposite side of the circumferential wall 243. FIG. 11D shows still another configuration in which the reductant is inserted through four orifices 242 and cycled clockwise.

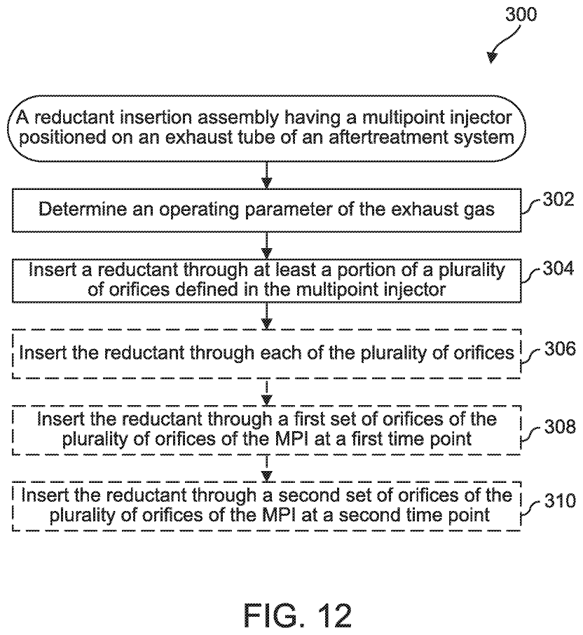

FIG. 12 is a schematic flow diagram of an example method 300 for inserting a reductant at a plurality of locations in an aftertreatment system (e.g., the aftertreatment system 100) via a multipoint injector (e.g., the multipoint injector 140, 240) coupled to an exhaust tube (e.g., the exhaust tube 102, 202) of the aftertreatment system.

The method 300 comprises determining an operating parameter of the exhaust gas, at 302. For example, the operating parameter determination circuitry 174a may receive an operating parameter signals from the engine 10, the first sensor 103, the second sensor 105 or any other sensor included in the aftertreatment system 100 and determine the operating parameter of the exhaust gas (e.g., an amount of NOx gases in the exhaust, a temperature of the exhaust gas, a flow rate and/or pressure of the exhaust gas) therefrom. The operating parameter determination circuitry 174a may determine if the reductant is to be inserted into the aftertreatment system 100, a flow rate and/or a volume of the exhaust gas to be inserted into the aftertreatment system 100.

At 304, a reductant is inserted through at least a portion of the plurality of orifices into a flow path of an exhaust gas flowing through the exhaust tube based on the operating parameter. For example, the reductant insertion control circuitry 174b may activate the reductant insertion assembly 112, and the reductant distributor control circuitry 174c may activate at least a portion of the valves 138 to communicate a reductant through a corresponding portion of the outlets 136, 236 to the respective orifices 142, 242 to which these outlets 136, 236 are coupled based on the operating parameter.

In some embodiments, the method 300 may comprise inserting the reductant through each of the plurality of orifices, at 306. For example, the reductant distributor control circuitry 174c may open each of the valves 138 of the reductant distributor causing the reductant to be communicated through each of the orifices 142, 242 into the flow path of the exhaust gas.

In some embodiment, the method 300 also comprises inserting the reductant through a first set of orifices of the plurality of orifices at a first time point causing the reductant to be inserted into a first location of the exhaust gas flow path, at 308. For example, the reductant distributor control circuitry 174c may be configured to open a first set of valves 138 of the reductant distributor 130, 230 causing the reductant to be inserted through a corresponding set of orifices 142/242 into the flow path of the exhaust gas, as previously described herein.

Furthermore, at 310, the reductant is inserted through a second set of orifices of the plurality of orifices different than the first set of orifices at a second time point causing the reductant to be inserted into a second location of the exhaust gas flow path different than the first location. For example, the reductant distributor control circuitry 174c may close the first set of valves 138 and open a second set of valves, different than the first set causing the reductant to be inserted through a corresponding second set of orifices 142, 242 into the exhaust tube 102 (e.g., at the exhaust tube 102, 202). In this manner, the reductant impacts different locations of the circumferential wall 243 defined by the multipoint injector 140, 240 during different insertion cycles rather than the same location on every cycle which reduces reductant deposits and enhances mixing of the reductant with the exhaust gas.

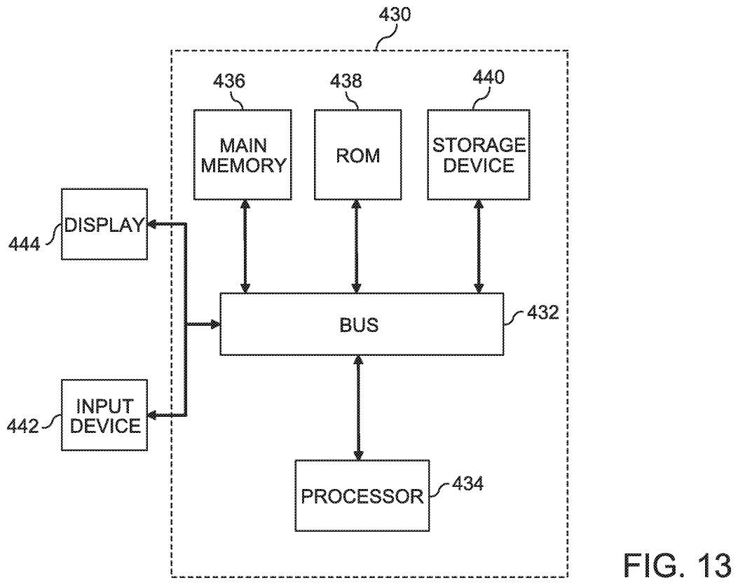

In some embodiments, the controller 170, the control circuitry 171 or any of the controllers described herein can be a system computer of an apparatus or system which includes the multipoint injector 140 and optionally, the reductant distributor 130. For example, FIG. 13 is a block diagram of a computing device 430 in accordance with an illustrative implementation. The computing device 430 can be used to perform any of the methods or the processes described herein, for example the method 300. The computing device 430 includes a bus 432 or other communication component for communicating information. The computing device 430 can also include one or more processors 434 or processing circuits coupled to the bus for processing information.

The computing device 430 also includes main memory 436, such as a random access memory (RAM) or other dynamic storage device, coupled to the bus 432 for storing information, and instructions to be executed by the processor 434. Main memory 436 can also be used for storing position information, temporary variables, or other intermediate information during execution of instructions by the processor 434. The computing device 430 may further include a read only memory (ROM) 438 or other static storage device coupled to the bus 432 for storing static information and instructions for the processor 434. A storage device 440, such as a solid-state device, magnetic disk or optical disk, is coupled to the bus 440 for persistently storing information and instructions.

The computing device 430 may be coupled via the bus 432 to a display 435, such as a liquid crystal display, or active matrix display, for displaying information to a user. An input device 442, such as a keyboard or alphanumeric pad, may be coupled to the bus 432 for communicating information and command selections to the processor 434. In another implementation, the input device 442 has a touch screen display 444.

According to various implementations, the processes and methods described herein can be implemented by the computing device 430 in response to the processor 434 executing an arrangement of instructions contained in main memory 436 (e.g., the operations of the method 300). Such instructions can be read into main memory 436 from another non-transitory computer-readable medium, such as the storage device 440. Execution of the arrangement of instructions contained in main memory 436 causes the computing device 430 to perform the illustrative processes described herein. One or more processors in a multi-processing arrangement may also be employed to execute the instructions contained in main memory 436. In alternative implementations, hard-wired circuitry may be used in place of or in combination with software instructions to effect illustrative implementations. Thus, implementations are not limited to any specific combination of hardware circuitry and software.

Although an example computing device has been described in FIG. 13, implementations described in this specification can be implemented in other types of digital electronic circuitry, or in computer software, firmware, or hardware, including the structures disclosed in this specification and their structural equivalents, or in combinations of one or more of them.

Implementations described in this specification can be implemented in digital electronic circuitry, or in computer software, firmware, or hardware, including the structures disclosed in this specification and their structural equivalents, or in combinations of one or more of them. The implementations described in this specification can be implemented as one or more computer programs, i.e., one or more modules of computer program instructions, encoded on one or more computer storage media for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple disks, or other storage devices). Accordingly, the computer storage medium is both tangible and non-transitory.

The operations described in this specification can be performed by a data processing apparatus on data stored on one or more computer-readable storage devices or received from other sources. The term “data processing apparatus” or “computing device” encompasses all kinds of apparatus, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

As used herein, the term “about” generally mean plus or minus 10% of the stated value. For example, about 0.5 would include 0.45 and 0.55, about 10 would include 9 to 11, about 1000 would include 900 to 1100.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Additionally, it should be understood that features from one embodiment disclosed herein may be combined with features of other embodiments disclosed herein as one of ordinary skill in the art would understand. Other substitutions, modifications, changes and omissions may also be made in the design, operating conditions and arrangement of the various exemplary embodiments without departing from the scope of the present invention.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

1. A reductant insertion system comprising:
a multipoint injector configured to be operatively coupled to an exhaust tube of an aftertreatment system, the multipoint injector comprising:
an injector body having a circumferential wall, and
a plurality of orifices extending through the circumferential wall of the injector body, each being located at a different circumferential position of the circumferential wall and being configured to insert the reductant into an exhaust gas flow path defined by the exhaust tube; and
a reductant distributor disposed remotely from the multipoint injector, the reductant distributor comprising:
a reductant distributor housing,
a plurality of outlets defined on a first sidewall of the reductant distributor housing, each of the plurality of outlets fluidly coupled to a corresponding orifice of the plurality of orifices of the multipoint injector via corresponding reductant delivery lines,
an inlet provided in a second sidewall of the reductant distributor housing and configured to receive the reductant, and
a plurality of valves disposed in the reductant distributor housing, each of the plurality of valves operatively coupled to a corresponding outlet of the plurality of outlets and configured to be selectively activated to communicate reductant to a predetermined set of orifices of the plurality of orifices.

2. The reductant insertion system of claim 1, wherein at least some of the plurality of orifices are inclined at an angle with respect to a flow axis of the exhaust gas flow path.

3. The reductant insertion system of claim 2, wherein each of the plurality of orifices is inclined at the same angle with respect to the flow axis of the exhaust gas flow path.

4. The reductant insertion system of claim 1, wherein the injector body defines a channel therethrough, the channel forming a portion of the exhaust gas flow path.

5. The reductant insertion system of claim 4, further comprising a plurality of flanges positioned at axial ends of the injector body and extending radially outward from the injector body, the flanges configured to abut corresponding axial ends of an exhaust tube first portion and an exhaust tube second portion of the exhaust tube.

6. (canceled)

7. The reductant insertion system of claim 1, further comprising a controller operatively coupled to the reductant distributor, the controller being configured to selectively activate a set of the plurality of valves so as to allow reductant to be communicated to a corresponding set of orifices of the plurality of orifices.

8. The reductant insertion system of claim 7, wherein the controller is configured to activate each of the plurality of valves simultaneously.

9. The reductant insertion system of claim 7, wherein the controller is configured to:
activate a first set of the plurality of valves at first time to cause the reductant to be inserted through a corresponding first set of orifices of the plurality of orifices into a first location of the exhaust gas flow path; and
activate a second set of the plurality of valves different than the first set of valves at a second time to cause the reductant to be inserted through a corresponding second set of orifices of the plurality of orifices into a second location of the exhaust gas flow path different from the first location.

10. An aftertreatment system for reducing constituents of an exhaust gas produced by an engine, the aftertreatment system comprising:
an exhaust tube defining an exhaust gas flow path for communicating the exhaust gas;
the reductant insertion system of claim 1, wherein the multi-point injector is operatively coupled to the exhaust tube.

11. The aftertreatment system of claim 10, further comprising a selective catalytic reduction system coupled to the exhaust tube.

12. The aftertreatment system of claim 11, wherein the exhaust tube comprises:
an exhaust tube first portion positioned upstream of the injector body; and
an exhaust tube second portion positioned downstream of the injector body,
wherein the injector body defines a channel therethrough, the channel forming a portion of the exhaust gas flow path.

13. The aftertreatment system of claim 12, wherein the multipoint injector further includes flanges positioned at axial ends of the injector body and extending radially outwards from the injector body, the flanges abutting corresponding axial ends of the exhaust tube first portion and the exhaust tube second portion.

14. A method for inserting a reductant into an exhaust tube of an aftertreatment system via a reductant insertion system comprising a multipoint injector fluidly coupled to the exhaust tube, the multipoint injector comprising an injector body having a circumferential wall, and a plurality of orifices extending through the circumferential wall, each being located at a different circumferential position of the circumferential wall, the reductant insertion system also including a reductant distributor disposed remotely from the multipoint injector and including a plurality of valves coupled to a corresponding orifice of the plurality of orifices via corresponding reductant delivery lines, the method comprising:
determining an operating parameter of an exhaust gas flowing through the aftertreatment system;
selectively activating at least one of the plurality of valves so as to communicate reductant from the at least one of the plurality of valves via a corresponding reductant delivery line to a corresponding orifice of the plurality of orifices, thereby inserting the reductant through the corresponding orifice into a flow path of the exhaust gas based on the operating parameter.

15. The method of claim 14, further comprising activating all of the plurality of valves so as to insert the reductant through each of the plurality of orifices.

16. The method of claim 14, further comprising activating a first set of the plurality of valves so as to insert the reductant through a corresponding first set of orifices of the plurality of orifices at a first time to cause the reductant to be inserted into a first location of the exhaust gas flow path.

17. The method of claim 16, further comprising activating a second set of the plurality of valves different from the first set of the plurality of valves so as to insert the reductant through a second set of orifices of the plurality of orifices different than the first set of orifices at a second time to cause the reductant to be inserted into a second location of the exhaust gas flow path different than the first location.

18. The method of claim 14, wherein at least some of the plurality of orifices are inclined with respect to a flow axis of the exhaust gas flow path.

19. The method of claim 18, wherein each of the plurality of orifices is inclined at the same angle with respect to the flow axis of the exhaust gas flow path.

20. The method of claim 14, wherein the injector body defines a channel therethrough, the channel forming a portion of the exhaust gas flow path.
